(19) United States
(12) Patent Application Publication
(10) Pub. No.: US 2025/0258295 A1
(43) Pub. Date: Aug. 14, 2025

(54) POSITION ESTIMATION APPARATUS

(71) Applicant: Honda Motor Co., Ltd., Tokyo (JP)

(72) Inventors: Daichi Saeki, Saitama (JP); Shunsuke Konishi, Saitama (JP); Shuhei Masuoka, Utsunomiya-shi (JP)

(21) Appl. No.: 19/048,941

(22) Filed: Feb. 9, 2025

(30) Foreign Application Priority Data
Feb. 14, 2024 (JP) 2024-020043

(51) Int. Cl. G01S 17/89; G01S 17/58; G01S 17/86; G01S 17/931; G06T 7/20; G06T 7/73

(52) U.S. Cl. CPC G01S 17/89; G01S 17/58; G01S 17/86; G01S 17/931; G06T 7/20; G06T 7/73; G06T 2207/10028; G06T 2207/30252

(57) ABSTRACT

A position estimation apparatus includes: a detection unit mounted on a moving body and irradiating surroundings of the moving body with an electromagnetic wave; and a microprocessor. The microprocessor is configured to perform acquiring point cloud data, the point cloud data including position information of a measurement point on a surface of an object from which a reflected wave of the electromagnetic wave is obtained and speed information indicating a relative moving speed of the measurement point; extracting road surface point cloud data corresponding to a road surface from the point cloud data; calculating a translational motion component and a rotational motion component, based on the position information and the speed information of the measurement point corresponding to the road surface point cloud data; and updating position information indicating a position of the moving body, based on the translational motion component and the rotational motion component.

### CROSS-REFERENCE TO RELATED APPLICATION

This application is based upon and claims the benefit of priority from Japanese Patent Application No. 2024-020043 filed on Feb. 14, 2024, the content of which is incorporated herein by reference.

### BACKGROUND

### Technical Field

The present invention relates to a position estimation apparatus configured to estimate a self-position of a moving body.

### Related Art

These years, there is a demand for a vehicle control system that leads to improvement of traffic safety and that contributes to development of a sustainable transportation system. As this type of device, there is a known device configured to calculate a self-position of a moving body, based on a displacement amount in position between frames of feature points that have been extracted from an image of a visual field on a forward side of the moving body (for example, see JP 2002-48513 A). In the device described in JP 2002-48513 A, feature points of an identical stationary object are extracted from images of two consecutive frames, and the self-position of the moving body is calculated from such a displacement amount between the frames of the feature points.

However, in a case where the self-position is estimated, based on the displacement amount of the feature points of the object in the surroundings of the moving body as in the device described in JP 2002-48513 A, if it is not possible to acquire the displacement amount between the frames of the feature points of an object, such as a case where there is no characteristic object in the surroundings of the moving body, the estimation accuracy of the self-position will decrease.

### SUMMARY

An aspect of the present invention is a position estimation apparatus including: a detection unit mounted on a moving body and configured to irradiate surroundings of the moving body with an electromagnetic wave to detect an external environment situation in the surroundings based on a reflected wave; and a microprocessor. The microprocessor is configured to perform: acquiring point cloud data for every predetermined time indicating a detection result of the detection unit, the point cloud data including position information of a measurement point on a surface of an object from which the reflected wave is obtained and speed information indicating a relative moving speed of the measurement point; extracting road surface point cloud data corresponding to a road surface from the point cloud data acquired in the acquiring; calculating a translational motion component and a rotational motion component, based on the position information and the speed information of the measurement point corresponding to the road surface point cloud data, the translational motion component indicating a movement amount and a moving direction of a translational motion of the moving body, the rotational motion component indicating a rotation amount and a rotating direction of a rotational motion of the moving body; and updating position information indicating a position of the moving body, based on the translational motion component and the rotational motion component calculated in the calculating.

### BRIEF DESCRIPTION OF DRAWINGS

The objects, features, and advantages of the present invention will become clearer from the following description of embodiments in relation to the attached drawings, in which:

FIG. 1 is a block diagram illustrating a configuration of main components of a vehicle control device including a position estimation apparatus according to an embodiment of the present invention;

FIG. 2 is a flowchart illustrating an example of processing to be performed by a CPU of the controller in FIG. 1;

FIG. 3A is a diagram for describing estimation of a rotation angle of a subject vehicle;

FIG. 3B is a diagram illustrating an example of a rotational motion component that has been estimated from a translational motion component;

FIG. 4 is a diagram schematically illustrating an example of point cloud data that acquired by LiDAR;

FIG. 5A is a diagram schematically illustrating an example of stationary point cloud data of a previous frame;

FIG. 5B is a diagram schematically illustrating an example of stationary point cloud data of a current frame;

FIG. 6A is a diagram schematically illustrating a situation in which positions of the stationary point cloud data of the previous frame and the stationary point cloud data of the current frame are aligned with each other; and

FIG. 6B is a diagram illustrating the stationary point cloud data of the previous frame and the stationary point cloud data of the current frame after the position alignment.

### DETAILED DESCRIPTION OF THE INVENTION

Hereinafter, embodiments of the present invention will be described with reference to the drawings. A position estimation apparatus according to an embodiment of the present invention is applicable to a vehicle having a self-driving capability, that is, a self-driving vehicle. Note that a vehicle to which the position estimation apparatus according to the present embodiment is applied will be referred to as a subject vehicle to be distinguished from other vehicles, in some cases. The subject vehicle may be any of an engine vehicle having an internal combustion engine (engine) as a driving power source, an electric vehicle having a driving motor as a driving power source, and a hybrid vehicle having an engine and a driving motor as a driving power source. The subject vehicle is capable of driving not only in a self-drive mode that does not require a driver's driving operation but also in a manual drive mode that requires a driver's driving operation.

While a self-driving vehicle is moving in the self-drive mode (hereinafter, referred to as self-driving or autonomous driving), such a self-driving vehicle recognizes an exterior environment situation in the surroundings of the subject vehicle, based on detection data of an in-vehicle detection unit such as a camera or a light detection and ranging (LiDAR). The self-driving vehicle generates a driving path (a target path) at a predetermined time to be elapsed after the current time, based on a recognition result, and controls a traveling actuator so that the subject vehicle travels along the target path.

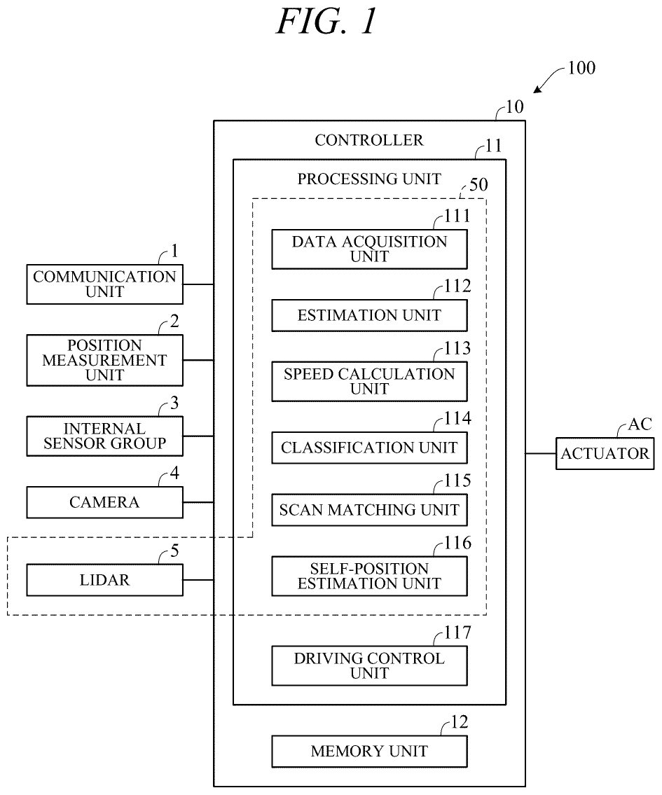

FIG. 1 is a block diagram illustrating a configuration of main components of a vehicle control device 100 including a position estimation apparatus. The vehicle control device 100 includes a controller 10, a communication unit 1, a position measurement unit 2, an internal sensor group 3, a camera 4, a LiDAR 5, and a traveling actuator AC. In addition, the vehicle control device 100 includes a position estimation apparatus 50, which constitutes a part of the vehicle control device 100. The position estimation apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for each predetermined management area, for example, a wireless LAN, Wi-Fi (registered trademark), Bluetooth (registered trademark), or the like. The acquired map information is output to a memory unit 12, and the map information is updated. The position measurement unit (GNSS unit) 2 includes a position measurement sensor that receives a position measurement signal transmitted from a position measurement satellite. The position measurement satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle (a forward side, a rearward side, and lateral sides). The LiDAR 5 irradiates a three-dimensional space in the surroundings of the subject vehicle with an electromagnetic wave (a reflected wave), and detects an exterior environment situation in the surroundings of the subject vehicle, based on the reflected wave. More specifically, the electromagnetic wave (a laser beam or the like) that has been irradiated from the LiDAR 5 is reflected on and returned from a certain point (a measurement point) on the surface of an object, and thus the distance from the laser source to such a point, the intensity of the electromagnetic wave that has been reflected and returned, the relative speed of the object located at the measurement point, and the like are measured. The electromagnetic wave of the LiDAR 5, which is attached to a predetermined position (a front part) of the subject vehicle is scanned in a horizontal direction and a vertical direction with respect to the surroundings (a forward side) of the subject vehicle. Thus, the position, the shape, the relative moving speed, and the like of an object (a moving object such as another vehicle or a stationary object such as a road surface or a structure) on a forward side of the subject vehicle are detected.

The actuator AC is a traveling actuator for controlling traveling of the subject vehicle. In a case where the driving power source is an engine, the actuators AC include a throttle actuator that adjusts an opening (throttle opening) of a throttle valve of the engine. In a case where the driving power source is a driving motor, the actuators AC includes the driving motor. The actuator AC also includes a brake actuator that operates a braking device of the subject vehicle and a steering actuator that actuates a steering device.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits, not illustrated, such as an I/O interface. Note that a plurality of ECUs having different functions such as an engine control ECU, a driving motor control ECU, and a braking device ECU can be separately provided, but in FIG. 1, the controller 10 is illustrated as an aggregation of these ECUs as a matter of convenience.

The memory unit 12 stores highly precise detailed map information (referred to as high-precision map information). The high-precision map information includes position information of roads, information of road shapes (curvatures or the like), information of road gradients, position information of intersections and branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, the memory unit 12 stores programs for various types of control, information such as a threshold for use in a program, and setting information for the in-vehicle detection unit such as the LiDAR 5.

The processing unit 11 includes, as a functional configuration, a data acquisition unit 111, an estimation unit 112, a speed calculation unit 113, a classification unit 114, a scan matching unit 115, a self-position estimation unit 116, and a driving control unit 117. Note that as illustrated in FIG. 1, the data acquisition unit 111, the estimation unit 112, the speed calculation unit 113, the classification unit 114, the scan matching unit 115, and the self-position estimation unit 116 are included in the position estimation apparatus 50. Details of the data acquisition unit 111, the estimation unit 112, the speed calculation unit 113, the classification unit 114, the scan matching unit 115, and the self-position estimation unit 116 included in the position estimation apparatus 50 will be described later.

In the self-drive mode, the driving control unit 117 generates a target path, based on an exterior environment situation (such as a size and a position of an object and a relative moving speed) in the surroundings of the vehicle that have been detected by the in-vehicle detection unit such as the LiDAR 5. Specifically, the driving control unit 117 generates the target path to avoid a collision or contact with the object or to follow the object, based on the exterior environment situation in the surroundings of the vehicle that has been detected by the in-vehicle detection unit such as the LiDAR 5 and the position of the subject vehicle that has been estimated by the position estimation apparatus 50. The driving control unit 117 controls the actuator AC so that the subject vehicle travels along the target path. Specifically, the driving control unit 117 controls the actuator AC along the target path to adjust an accelerator opening or to actuate the braking device or the steering device. Note that in the manual drive mode, the driving control unit 117 controls the actuator AC in accordance with a driving command (a steering operation or the like) from the driver that has been acquired by the internal sensor group 3.

The position estimation apparatus 50 will be described in detail. As described above, the position estimation apparatus 50 includes the data acquisition unit 111, the estimation unit 112, the speed calculation unit 113, the classification unit 114, the scan matching unit 115, and the self-position estimation unit 116. The position estimation apparatus 50 further includes the LiDAR 5.

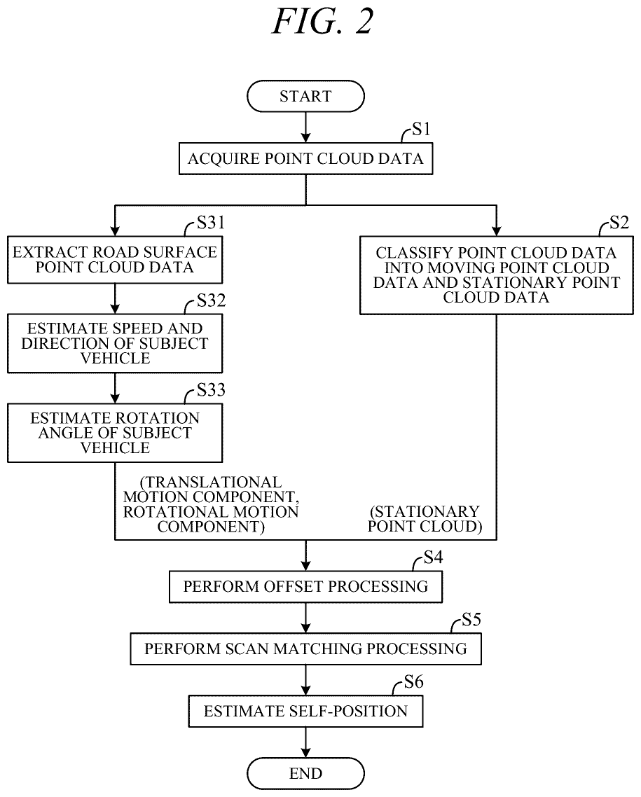

First, an overall flow of the self-position estimation processing performed by the position estimation apparatus 50 will be described. FIG. 2 is a flowchart illustrating an example of processing to be performed by the CPU of the controller 10 in FIG. 1 in accordance with a predetermined program. The processing illustrated in this flowchart is repeated at a predetermined cycle, while the position estimation apparatus 50 is running. More specifically, the processing is repeated whenever the detection data of the LiDAR 5 is acquired by the data acquisition unit 111, that is, every predetermined time (at time intervals determined by the frame rate of the LiDAR 5). Note that in consideration of the necessity for traffic safety, the calculation load, and the like, the interval of performing the processing of FIG. 2 may be changeable instead of being constant.

When the detection data (point cloud data) of the LiDAR 5 is acquired (step S1), first, processing of classifying the point cloud data into moving point cloud data and stationary point cloud data is performed (step S2).

Next, after the stationary point cloud data of a previous frame is offset (step S4), predetermined scan matching processing is performed to superimpose the stationary point cloud data of the previous frame on the stationary point cloud data of a current frame, and thus an azimuth angle difference and a moving vector of the subject vehicle 101 are estimated (step S5). The moving vector represents a moving direction of a representative point (such as a center of gravity) of the subject vehicle 101 between the frames and a moving speed in such a moving direction. The azimuth angle difference denotes an angle difference in azimuth of the current frame from the azimuth of the previous frame of the subject vehicle 101. Hereinafter, X axis is defined as an axis along a vehicle length direction of the moving body (a front-rear direction with respect to the vehicle body), and Y axis and Z axis are respectively defined as an axis in a lateral direction and an axis in a height direction with respect to the vehicle length direction. Note that the moving vector may be represented in two dimensions (X, Y) or three dimensions (X, Y, Z). In addition, the azimuth angle difference may be a one-axis angle (Z-axis rotation angle), a two-axis angle (X-axis rotation angle and Z-axis rotation angle), or a three-axis angle (X-axis rotation angle, Y-axis rotation angle, and Z-axis rotation angle). For the scan matching processing, iterative closest point (ICP) or normal distributions transform (NDT) may be used, or any other method may be used. The azimuth angle difference and the moving vector of the subject vehicle 101 estimated in step S5 are accumulated, and the self-position estimation processing (not illustrated) for estimating the self-position (traveling position of the subject vehicle 101) is performed in step S6, based on the accumulated azimuth angle differences and moving vectors.

As an example of the offsetting method in step S4, there is a method for offsetting the stationary point cloud data of the previous frame by using the moving vector and the azimuth angle difference of the subject vehicle 101 between the frames (between the frame before the previous frame and the previous frame) estimated by the scan matching processing (S5) in a previous cycle. On the other hand, in a scene in which it is difficult to obtain a feature point of a stationary object, a corresponding feature point is not present or it is difficult to find it between the frames. Thus, an error is easily included in the azimuth angle difference and the moving vector of the subject vehicle 101 estimated in the scan matching processing (S5). The scene in which it is difficult to obtain the feature point of the stationary object includes, for example, a scene in which the subject vehicle 101 travels on a road where there is almost no three-dimensional object such as a utility pole or trees in the surroundings (a farm road or the like passing through a farm field), a scene in which the subject vehicle travels in a tunnel, a scene in which the subject vehicle travels on a road between large buildings or walls on the left and right, and a scene in which the subject vehicle travels in parallel with vehicles while traveling alongside large vehicles such as buses.

In a case where an error is included in the azimuth angle difference and the moving vector of the subject vehicle 101 estimated in the scan matching processing (S5), such an error is accumulated in the self-position estimation processing (S6), and the estimation accuracy of the self-position may be degraded. For this reason, in order to handle such an issue, the position estimation apparatus 50 performs processing (steps S31 to S33) of estimating a moving speed and a rotation angle of the subject vehicle 101 in parallel with classification processing of point cloud (S2), as illustrated in FIG. 2. Then, the offset processing (S4) is performed using the moving speed and rotation angle of the subject vehicle 101 that have been estimated.

The processing in each step of FIG. 2 will be described in detail.

### <Acquisition of Point Cloud (S1)>

The data acquisition unit 111 acquires, as detection data of the LiDAR 5, four-dimensional data (hereinafter, referred to as point cloud data) including position information indicating three-dimensional position coordinates of a measurement point on a surface of the object from which the reflected wave of the LiDAR 5 is obtained, and speed information indicating a relative moving speed of the measurement point. The point cloud data is acquired by the LiDAR 5 in the unit of frames, specifically, every predetermined time (at time intervals determined by the frame rate of the LiDAR 5).

### <Classification of Point Cloud (S2)>

The classification unit 114 classifies the point cloud data that has been acquired by the data acquisition unit 111 into moving point cloud data corresponding to the measurement point at which the absolute value of the absolute moving speed is equal to or higher than a predetermined speed Th_V and stationary point cloud data corresponding to the measurement point at which the absolute value is lower than the predetermined speed Th_V. The absolute moving speed of the measurement point is calculated by the speed calculation unit 113 in the processing of step S32 to be described later.

### <Extraction of Road Surface Point Cloud (S31)>

The estimation unit 112 extracts point cloud data obtained by removing information of measurement points corresponding to a three-dimensional object from the point cloud data that has been acquired by the data acquisition unit 111, that is, point cloud data corresponding to a road surface (hereinafter, referred to as road surface point cloud data) in the surroundings of the subject vehicle 101. Note that the road surface point cloud data may be extracted in a plane approximation method, or may be extracted in any other method.

### <Estimation of Moving Speed and Moving Direction of Subject Vehicle (S32)>

The estimation unit 112 calculates a unit vector ei indicating the direction of a relative moving speed vi, based on the road surface point cloud data, that is, position coordinates (xi, yi, zi) included in four-dimensional data (xi, yi, zi, vi) of a measurement points Pi (i=1, 2, . . . , n) corresponding to the road surface. Specifically, the estimation unit 112 calculates the unit vector ei in the following Formula (i).

$${e}_{i} = \frac{( {x}_{i} , {y}_{i} , {z}_{i} )}{‖ {x}_{i} , {y}_{i} , {z}_{i} ‖} = ( {x}_{e i} , {y}_{e i} , {z}_{e i} ) \qquad Formula ( i )$$

Next, the estimation unit 112 estimates the moving speed (the absolute moving speed) Vself of the subject vehicle 101. Specifically, the estimation unit 112 sets a conversion formula for converting the relative moving speed vi of the measurement point Pi corresponding to the road surface into the absolute moving speed, as an objective function L, and solves an optimization problem for optimizing the objective function L to be closer to zero. The measurement point Pi is a measurement point on a road surface, and thus the absolute speed of each measurement point must be zero. Therefore, by optimizing the objective function L to be closer to zero, it becomes possible to estimate Vself that is correct. Vself is represented by speed components in XYZ-axis directions as indicated in the following formula (ii). The objective function L is expressed by the following formula (iii). By solving the above optimization problem, Vself that makes the right side of formula (iii) zero is searched for. Note that zero may be set to Vself as an initial value, or Vself that has been estimated in a previous frame may be set.

$${V}_{self} = ( {v}_{x} , {v}_{y} , {v}_{z} ) \qquad Formula ( ii )$$

$$L ( V , f ( A , {V}_{self} ) ) = V + A \cdot {V}_{self}^{T} \qquad Formula ( iii )$$

In the formula (iii), A denotes a matrix of unit vectors ei of n measurement points corresponding to the road surface, and is expressed by a formula (iv). In addition, in the formula (iii), V denotes a matrix of 1×n representing speed components (the relative moving speeds) of n measurement points Pi corresponding to the road surface, and is expressed by a formula (v). The estimation unit 112 acquires Vself obtained by solving the above optimization problem, as an estimated value of the absolute moving speed of the subject vehicle 101 in a current frame. The estimated value Vself acquired by the estimation unit 112 is used in the estimation of the rotation angle of the subject vehicle (S33).

$$A = {[ {e}_{1} , {e}_{2} , ⋯ , {e}_{n} ]}^{T} = [ \begin{matrix}{x}_{e 1} & {y}_{e 1} & {z}_{e 1} \\ {x}_{e 2} & {y}_{e 2} & {z}_{e 2} \\ ⋮ & ⋮ & ⋮ \\ {x}_{en} & {y}_{en} & {z}_{en}\end{matrix} ] \qquad Formula ( iv )$$

$$V = {[ {v}_{1} , {v}_{2} , ⋯ , {v}_{n} ]}^{T} \qquad Formula ( v )$$

The speed calculation unit 113 calculates the absolute moving speeds of all measurement points, more specifically, all measurement points including the measurement points corresponding to the three-dimensional object, based on the absolute moving speed Vself of the subject vehicle 101 that has been estimated by the estimation unit 112. The absolute moving speed has a negative value when approaching the subject vehicle, and has a positive value when leaving the subject vehicle. As described above, the absolute moving speed that has been calculated by the speed calculation unit 113 is used in the classification of point cloud (S2).

### <Estimation of Rotation Angle of Subject Vehicle (S33)>

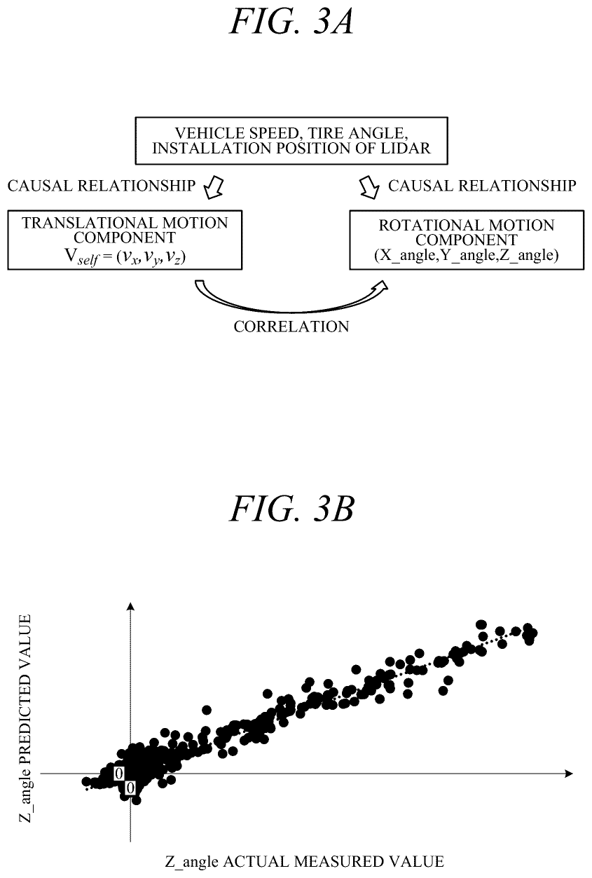

FIG. 3A is a diagram for describing estimation of a rotation angle of the subject vehicle. The movement of an object in the three-dimensional space can be expressed by six degrees of freedom including a translational motion component, specifically, moving speeds vx, vy, and vz in X-axis direction, Y-axis direction, and Z-axis direction, and a rotational motion component, specifically, rotation angles X_angle, Y_angle, and Z_angle in X-axis direction, Y-axis direction, and Z-axis direction. On the other hand, the movement of the subject vehicle 101 can be expressed by three degrees of freedom including a moving speed (vehicle speed) of the subject vehicle 101, a tire angle, and an installation position of the LiDAR. The subject vehicle 101 is one object, and thus it is assumed that there is a causal relationship between the above three degrees of freedom representing the movement of the subject vehicle 101 and the above six degrees of freedom representing the movement of an object in the three-dimensional space (the above translational motion component and the above rotational motion component). In addition, the above translational motion component and the above rotational motion component both have a causal relationship with the above three degrees of freedom representing the movement of the subject vehicle 101, and thus it is assumed that there is a correlation between the translational motion component and the rotational motion component as illustrated in FIG. 3A. Therefore, from the translational motion component Vself of the subject vehicle 101 that has been calculated, based on the road surface point cloud data, it should be possible to estimate the rotational motion component of the subject vehicle 101 using the above causal relationship and the above correlation. FIG. 3B is a diagram illustrating an example of a rotational motion component Z_angle on Z axis that has been estimated from vx and vy of the translational motion component Vself using multiple regression analysis. In the graph of FIG. 3B, the vertical axis represents the estimated value (predicted value) of Z_angle, and the horizontal axis represents the actual measured value of Z_angle. As illustrated in FIG. 3B, the estimated value of the rotational motion component Z_angle on Z-axis in the multiple regression analysis is substantially equal to the actual measured value, and it can be understood that it is possible to estimate the rotational motion component Z_angle on Z-axis from vx and vy of the translational motion component Vself. Note that FIG. 3B illustrates only the estimation results of the rotational motion component Z_angle on Z axis of the subject vehicle 101, but it is also possible to similarly estimate the rotational motion component Y_angle on Y axis of the subject vehicle 101 from vx and vz of the translational motion component Vself of the subject vehicle 101. Similarly, it is also possible to estimate the rotational motion component X_angle on X axis of the subject vehicle 101 from vy and vz of the translational motion component Vself of the subject vehicle 101. Note that the method for estimating the rotational motion component of the subject vehicle 101 is not limited to the multiple regression analysis, and any other method such as machine learning may be used. Further, the rotational motion component of the subject vehicle 101 may be estimated using a motion model at the time of vehicle design. Furthermore, a sensor such as a gyro sensor may be used for directly acquiring the rotational motion component of the subject vehicle 101.

### <Offset Processing (S4) and Scan Matching Processing (S5)>

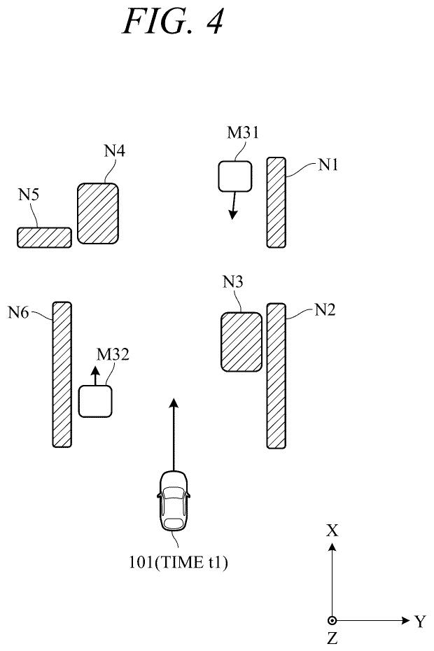

First, the scan matching processing (S5) will be described. FIGS. 4, 5A, 5B, 6A, and 6B are diagrams for describing the scan matching processing between a previous frame and a current frame. In FIG. 4, an arrow applied to the subject vehicle 101 indicates the vehicle length direction (the front-rear direction of the vehicle body) of the subject vehicle 101, that is, X-axis direction. In addition, a lateral direction (a left-right direction in FIG. 4) and a height direction (a direction from the depth side to the near side in FIG. 4) with respect to X-axis direction respectively represent Y-axis direction and Z-axis direction. Note that the definitions of X-axis direction, Y-axis direction, and Z-axis direction are also similar in the other drawings, and representations of X-axis, Y-axis, and Z-axis are omitted in such drawings. FIG. 4 illustrates an example of a schematic diagram when the point cloud data that has been acquired by the LiDAR 5 at a past time (time t1) is viewed from a top surface (Z-axis direction). Regions N1 to N6 schematically represent the measurement point cloud corresponding to the stationary object, more specifically, the position and the size of the measurement point cloud. The stationary object includes a road surface of a road on which the subject vehicle 101 is traveling, a structure such as a wall or a separation zone installed on a lateral side of the road, and other vehicles parked on a road shoulder. Regions M31 and M32 each schematically represent the measurement point cloud corresponding to a moving object, more specifically, the position and the size of the measurement point cloud. Note that hereinafter, a target object to be detected by the LiDAR 5 will be referred to as an object including a person. Therefore, the moving object includes a moving person (a pedestrian or the like), in addition to a moving vehicle such as an automobile or a bicycle. Arrows applied to the regions M31 and M32 respectively indicate the moving directions of the moving objects.

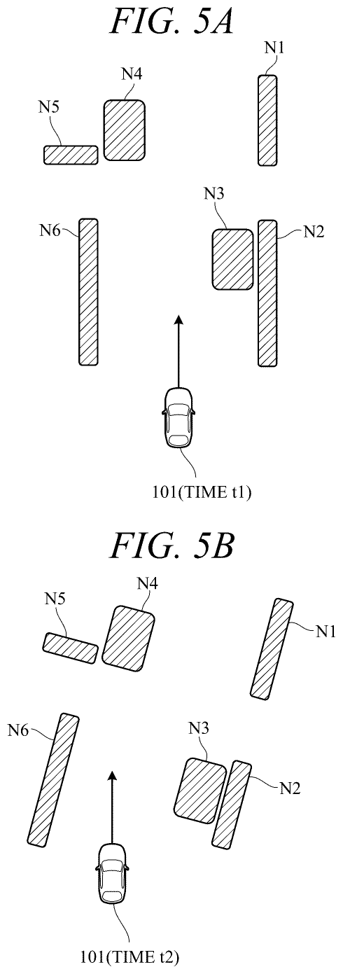

FIG. 5A schematically illustrates the point cloud data of FIG. 4, that is, the stationary point cloud data that has been classified from the point cloud data acquired by the LiDAR 5 at the past time (time t1). FIG. 5B schematically illustrates the stationary point cloud data that has been classified from the point cloud data acquired by the LiDAR 5 at a current time (time t2), when a predetermined time elapsed from the predetermined past time (time t1).

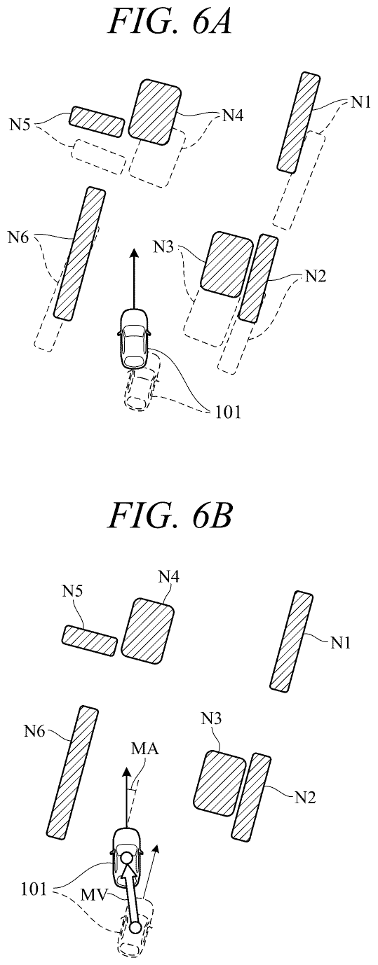

First, the scan matching unit 115 performs predetermined scan matching processing to align the positions of the stationary point cloud data (FIG. 5A) of the previous frame with the stationary point cloud data (FIG. 5B) of the current frame, and estimates the azimuth angle difference and the moving vector of the subject vehicle 101 for a predetermined time (between the frames). In the above scan matching processing, more specifically, the position alignment is performed on the stationary point cloud data of the previous frame with the current frame other than the road surface point cloud data, that is, between the stationary point cloud data corresponding to a three-dimensional object (hereinafter, referred to as stationary three-dimensional point cloud data). FIGS. 6A and 6B schematically illustrate a situation in which the positions of the stationary point cloud data of the previous frame (FIG. 5A) and the stationary point cloud data of the current frame (FIG. 5B) are aligned with each other. In FIG. 6A, the stationary point cloud data of the previous frame is indicated by broken lines, and the stationary point cloud data of the current frame is indicated by solid lines. The scan matching unit 115 searches for (estimates) the azimuth angle difference and the moving vector of the subject vehicle 101 so that the measurement point clouds N1 to N6 of the previous frame indicated by the broken lines respectively superimpose (match) the measurement point clouds N1 to N6 of the current frame indicated by the solid lines. FIG. 6B illustrates the stationary point cloud data of the previous frame and the stationary point cloud data of the current frame after the position alignment. In FIG. 6B, an angle MA represents the azimuth angle difference of the subject vehicle 101 between the frames. A white arrow MV represents a moving vector of the subject vehicle 101 between the frames. A white circle in the drawing schematically represents the center of gravity of the subject vehicle 101. The scan matching unit 115 solves an optimization problem that minimizes a deviation (error) between the positions of the measurement point clouds N1 to N6 in the previous frame and the positions of the measurement point clouds N1 to N6 in the current frame after the position alignment, and outputs final search results (estimation results) of the azimuth angle difference and the moving vector of the subject vehicle 101. Note that in order to reduce the calculation load, after the three-dimensional point cloud data is converted into two-dimensional point cloud data represented in an XY coordinate system, the above position alignment may be performed.

In the offset processing (S4), the scan matching unit 115 offsets the stationary point cloud data of the previous frame using the moving vector and the azimuth angle difference of the subject vehicle 101 between the frames (between the frame before the previous frame and the previous frame) that have been estimated in the scan matching processing (S5) in the previous cycle. In the scan matching processing (S5) performed after the offset processing (S4), the scan matching unit 115 aligns the position of the stationary point cloud data, which has been offset, of the previous frame as an initial value with the position of the stationary point cloud data of the current frame. In this manner, the moving vector and the azimuth angle of the subject vehicle 101 that have been estimated in the scan matching processing are used as initial values in solving the optimization problem in the scan matching processing next time.

### <Self-Position Estimation Processing (S6)>

The self-position estimation unit 116 accumulates the azimuth angle difference and the moving vector of the subject vehicle 101 that have been estimated in the scan matching processing (S5), and estimates the self-position (traveling position of the subject vehicle 101), based on the accumulated azimuth angle differences and moving vectors.

According to the embodiments that have been described heretofore, the following operation and effect are obtained.

(1) The position estimation apparatus 50 includes: the LiDAR 5, which is mounted on the subject vehicle 101, which irradiates surroundings of the subject vehicle 101 with an electromagnetic wave, and which detects an external environment situation in the surroundings of a moving object, based on a reflected wave; the data acquisition unit 111, which acquires point cloud data for every predetermined time indicating a detection result of the LiDAR 5, the point cloud data including position information of a measurement point on a surface of an object from which the reflected wave is obtained and speed information indicating a relative moving speed of the measurement point; the estimation unit 112, which serves as an extraction unit configured to extract road surface point cloud data corresponding to a road surface from the point cloud data that has been acquired by the data acquisition unit 111; the scan matching unit 115, which serves as a motion component calculation unit configured to calculate a translational motion component (vx, vy, and vz in FIG. 3A) and a rotational motion component (X_angle, Y_angle, and Z_angle in FIG. 3A), based on the position information and the speed information of the measurement point corresponding to the road surface point cloud data, the translational motion component indicating a movement amount and a moving direction of a translational motion of the subject vehicle 101, the rotational motion component indicating a rotation amount and a rotating direction of a rotational motion of the subject vehicle 101; and the self-position estimation unit 116, which serves as an update unit configured to update the position information indicating a position of the subject vehicle 101, based on the translational motion component and the rotational motion component that have been calculated by the scan matching unit 115. This enables the position of the subject vehicle 101 to be accurately estimated regardless of a surrounding environment of the subject vehicle 101 while traveling.

(2) The position estimation apparatus 50 further includes: the speed calculation unit 113, which calculates an absolute moving speed of each of a plurality of measurement points corresponding to the point cloud data that has been acquired by the data acquisition unit 111, based on the speed information of the measurement point and the translational motion component of the subject vehicle 101; and the classification unit 114, which classifies the point cloud data into stationary point cloud data in which an absolute value of the absolute moving speed that has been calculated by the speed calculation unit 113 is smaller than a predetermined speed and moving point cloud data in which the absolute value is equal to or higher than the predetermined speed. The self-position estimation unit 116 further offsets the stationary point cloud data at a past time that is a predetermined time before a current time, based on the translational motion component and the rotational motion component that have been calculated by the scan matching unit 115, also searches for the translational motion component and the rotational motion component that minimize a position error between corresponding measurement points of the stationary point cloud data at the current time and the stationary point cloud data that has been offset, and updates the position information of the subject vehicle 101, based on the translational motion component and the rotational motion component that have been obtained by searching. This enables an initial value to be appropriately set in solving the optimization problem in the scan matching processing, so that acquisition of an erroneous local solution as a search result can be suppressed.

(3) The scan matching unit 115 calculates the translational motion component of the subject vehicle 101, based on the position information and the speed information of the measurement point corresponding to the road surface point cloud data, and calculates the rotational motion component from the translational motion component that has been calculated, based on a predetermined correlation between the translational motion component and the rotational motion component. The above correlation is defined beforehand, based on the installation position of the LiDAR 5 in the subject vehicle 101, a moving speed (traveling speed) of the subject vehicle 101, and a steering angle (tire angle) of the subject vehicle 101. In this manner, by acquiring the information (the moving speed and the rotation angle of the subject vehicle 101) used for the offset processing (S4) from the current frame, the self-position can be accurately estimated even in a scene in which it is difficult to find corresponding feature points between the frames or there is no corresponding feature point between the frames.

The above-described embodiments can be modified in various manners. Hereinafter, modifications will be described. In the above embodiment, the LiDAR 5 as a detection unit is mounted on the vehicle, irradiates the three-dimensional space in the surroundings of the vehicle with the electromagnetic wave, and detects the exterior environment situation in the surroundings of the vehicle, based on the reflected wave. However, the detection unit may be a radar or the like, instead of the LiDAR. For example, the detection unit may be a four-dimensional imaging radar that irradiates with a millimeter radio wave and receives a reflected wave to acquire four-dimensional information (point cloud data) of a distance, an azimuth angle, an elevation angle, and a relative moving speed of a measurement point on a surface of an object included in a three-dimensional space. In addition, the moving body in which the detection unit is mounted may be a self-propelled robot, instead of the vehicle.

In addition, in the above embodiment, the estimation unit 112, which serves as the information acquisition unit, performs the position alignment on the stationary point cloud data (FIG. 5A) of the previous frame with the stationary point cloud data (FIG. 5B) of the current frame, and estimates the azimuth angle difference and the moving vector of the subject vehicle 101 for a predetermined time (between the frames). However, after converting the three-dimensional stationary point cloud data into two-dimensional stationary point cloud data represented in an XY coordinate system, the information acquisition unit may perform the above-described position alignment. Further, the information acquisition unit may perform the above-described position alignment using not only the stationary point cloud data at the past time (time t1) but also the stationary point cloud data at a plurality of past times, that is, using not only the stationary point cloud data of the previous frame but also the stationary point cloud data of the plurality of past frames. In this manner, by using the stationary point cloud data at the plurality of past frames, it becomes possible to perform the above-described position alignment satisfactorily even when a stationary object on a forward side of the subject vehicle 101 is temporarily shielded by another vehicle or the like, so that the robustness can be improved.

Furthermore, in the above embodiment, the position estimation apparatus 50 is applied to a self-driving vehicle, but the position estimation apparatus 50 is also applicable to any vehicle other than the self-driving vehicle. For example, the position estimation apparatus 50 is also applicable to a manually driven vehicle including advanced driver-assistance systems (ADAS).

The above embodiment can be combined as desired with one or more of the above modifications. The modifications can also be combined with one another.

According to the present invention, the self-position can be accurately estimated regardless of a surrounding environment of the moving body.

Above, while the present invention has been described with reference to the preferred embodiments thereof, it will be understood, by those skilled in the art, that various changes and modifications may be made thereto without departing from the scope of the appended claims.

What is claimed is:

1. A position estimation apparatus comprising:
a detection unit mounted on a moving body and configured to irradiate surroundings of the moving body with an electromagnetic wave to detect an external environment situation in the surroundings based on a reflected wave; and
a microprocessor, wherein
the microprocessor is configured to perform:
acquiring point cloud data for every predetermined time indicating a detection result of the detection unit, the point cloud data including position information of a measurement point on a surface of an object from which the reflected wave is obtained and speed information indicating a relative moving speed of the measurement point;
extracting road surface point cloud data corresponding to a road surface from the point cloud data;
calculating a translational motion component and a rotational motion component, based on the position information and the speed information of the measurement point corresponding to the road surface point cloud data, the translational motion component indicating a movement amount and a moving direction of a translational motion of the moving body, the rotational motion component indicating a rotation amount and a rotating direction of a rotational motion of the moving body; and
updating position information indicating a position of the moving body, based on the translational motion component and the rotational motion component.

2. The position estimation apparatus according to claim 1, wherein
the microprocessor is configured to further perform
calculating an absolute moving speed of each of a plurality of the measurement points corresponding to the point cloud data, based on the speed information of the measurement point and the translational motion component of the moving body; and
classifying the point cloud data into stationary point cloud data in which an absolute value of the absolute moving speed is smaller than a predetermined speed and moving point cloud data in which the absolute value is equal to or higher than the predetermined speed, wherein
the microprocessor is configured to perform
the updating including offsetting the stationary point cloud data at a past time before a current time by a predetermined time, based on the translational motion component and the rotational motion component, also searching for the translational motion component and the rotational motion component minimizing a position error between corresponding measurement points of the stationary point cloud data at the current time and the stationary point cloud data after the offsetting, and updating the position information of the moving body, based on the translational motion component and the rotational motion component obtained by the searching.

3. The position estimation apparatus according to claim 1, wherein
the microprocessor is configured to perform
the calculating including calculating the translational motion component of the moving body, based on the position information and the speed information of the measurement point corresponding to the road surface point cloud data, and calculating the rotational motion component from the translational motion component, based on a predetermined correlation between the translational motion component and the rotational motion component.

4. The position estimation apparatus according to claim 3, wherein
the correlation is defined based on an installation position of the detection unit in the moving body, a moving speed of the moving body, and a steering angle of the moving body.

5. The position estimation apparatus according to claim 1, wherein
the detection unit is a LiDAR or a radar.
